(19) United States
(12) Patent Application Publication
(10) Pub. No.: US 2024/0318541 A1
(43) Pub. Date: Sep. 26, 2024

(54) Method for determining transmissibilty in numerical simulation of oil and gas reservoirs on unstructured grids

(71) Applicant: Exploration & Production Research Institute of SINOPEC North-China Oil & Gas Company, Zhengzhou city (CN)

(72) Inventors: Yongyi Zhou, Zhengzhou city (CN); Bo Hu, Zhengzhou city (CN); Kui Chen, Zhengzhou city (CN); Yongming He, Chengdu City (CN); Jiawei Zhang, Zhengzhou city (CN); Yaonan Yu, Zhengzhou city (CN); Shenqi Peng, Zhengzhou city (CN); Yuanxiang Sun, Zhengzhou city (CN); Lu Cui, Zhengzhou city (CN)

(21) Appl. No.: 18/679,220

(22) Filed: May 30, 2024

(30) Foreign Application Priority Data
Jul. 12, 2023 (CN) 202310853709.5

(51) Int. Cl. E21B 47/02; G01V 20/00

(52) U.S. Cl. CPC E21B 47/02; G01V 20/00; E21B 2200/20

(57) ABSTRACT

The present invention relates to development research of oil and gas fields, and more particularly to a method for determining transmissibilty in numerical simulation of oil and gas reservoirs on unstructured grids. Based on the core seepage experimental data and well logging data of the drilled wells, the method takes into account the centroid distance of two adjacent grids as well as seepage direction vectors in the oil and gas reservoir simulation, and then adopts effective seepage area and directional permeability of the interface between the adjacent grids in seepage direction to calculate the transmissibilty. The present invention further verifies the reliability of the method by a rectangular grid example (rectangular grid is a special case of unstructured grids) whose accurate transmissibilty values can be obtained. The method of the present invention is simple, easy to understand and realize, operable, effective and practical.

### CROSS REFERENCE OF RELATED APPLICATION

The present invention claims priority under 35 U.S.C. 119(a-d) to CN 202310853709.5, filed Jul. 12, 2023.

### BACKGROUND OF THE PRESENT INVENTION

### Field of Invention

The present invention relates to development research of oil and gas fields, and more particularly to a method for determining transmissibilty in numerical simulation of oil and gas reservoirs on unstructured grids.

### Description of Related Arts

Conventionally, the regular structural grid is the mainstream grid system for reservoir numerical simulation. However, the structural grid is not suitable for simulating complex well trajectories such as fishbone branching wells, and is not suitable for complex geological features such as tilted faults, tilted fractures, stratigraphic pinchout, and reservoir boundaries of different shapes. Comparatively speaking, unstructured grids have the advantages of flexible node geometric topology, grid size distribution that is easy to be controlled, local refinement and adaptive processing, and thus are more suitable for the gridding of oil and gas reservoirs with complex shape features. The generation technology of unstructured grids is becoming more and more mature, but there is almost no literature available on the determination of the transmissibilty between unstructured grids, which is essential in the simulation process of oil and gas reservoirs. The only literature that can be accessed is the expression for calculating the transmissibilty of unstructured grids given by Ran et al. in their Chinese patents (CN114429525A, CN105160134A). Unfortunately, such expression is only a generic purely mathematical description of the definition of transmissibilty, and does not involve the method for determining relevant variables in the expression, which makes it difficult to be applied. Furthermore, the simulation grid permeability does not take into account the anisotropy of permeability, which is inconsistent with the actual situation. For example, the permeability of the simulation grid along the flow direction of a river channel and the permeability perpendicular to the flow direction of the river channel should be different from each other. For this reason, the present invention proposes a method for determining transmissibilty between unstructured grids based on the concept of directional permeability. The reliability of the method can be verified by a rectangular grid example where accurate values of transmissibilty can be obtained. (Remarks: rectangular grid is a special case of unstructured grid).

In order to elaborate on the methodological basis of the present invention, the following is a brief introduction to the relevant knowledge of transmissibilty in numerical simulation of oil and gas reservoirs.

### (1) Definition of Transmissibilty in Oil and Gas Reservoir Simulation

The fluid exchange between two adjacent grids in the numerical simulation of oil and gas reservoirs is:

$${Q}_{L} = \frac{{K}_{L} k r}{u} \frac{Δ P}{D i {s}_{L}} {A}_{L} = \frac{{K}_{L}}{D i {s}_{L}} {A}_{L} \frac{k r}{u} Δ P$$

The parameter term

$$\frac{{K}_{L}}{D i {s}_{L}} {A}_{L}$$

that do not change with time during the simulation process is defined as the transmissibilty multiplier, often referred to as transmissibilty, and denoted by the symbol TA_{L}.

From the above definition of transmissibilty and the model for calculating the fluid exchange between two grids, it can be obtained that:

$$T {A}_{L} = \frac{{K}_{L}}{D i {s}_{L}} {A}_{L} = {Q}_{L} / ( \frac{k r}{u} Δ P )$$

wherein:
L: the direction of seepage between two adjacent grids; Q_{L}: the amount of fluid exchange between two adjacent grids;
K_{L}: the permeability of the reservoir in a direction L; kr: the relative permeability of the fluid; u: the viscosity of the fluid;
ΔP: the pressure difference between two adjacent grids;
Dis_{L}: the distance between centroids of two adjacent grids in the direction L (i.e., the projected length of the distance between centroids in the direction L);
A_{L}: the effective seepage area between two adjacent grids in the direction L, i.e., the projected area of a shared grid surface on a plane perpendicular to seepage direction;
TA_{L}: the transmissibilty between two adjacent grids in the direction L.

In numerical simulation of oil and gas reservoirs, the generic purely mathematical description of the definition of transmissibilty is:

$${T}_{i , j} = \frac{{c}_{i} \cdot {c}_{j}}{{c}_{i} + {c}_{j}}$$

wherein:

$${c}_{i} = {A}_{i , j} \cdot \frac{{K}_{i}}{{D}_{i}} \cdot {( \vec{n} \cdot \vec{f} )}_{i} {c}_{j} = {A}_{i , j} \cdot \frac{{K}_{j}}{{D}_{j}} \cdot {( \vec{n} \vec{f} )}_{j}$$

i and j are the mark numbers of the adjacent grids; T_{i,j}: the transmissibilty between the grids i and j;
cᵢ: the shape factor of the grid i; cⱼ: the shape factor of the grid j; Kᵢ: the permeability of the grid i; Kⱼ: the permeability of the grid j;
A_{i,j}: the contact area between the grids i and j; Dᵢ: the distance from the centroid of the grid i to the center of the grid contact surface; Dⱼ: the distance from the centroid of the grid j to the center of the grid contact surface; \vec{n}·\vec{f}: the orthogonality normal correction of the grids.

From the generic purely mathematical description of the definition of transmissibilty, it is difficult to directly calculate and determine the transmissibilty between two adjacent grids, and thus each relevant mathematical notation has to be transformed into a model expression that can be easily understood to facilitate the application.

### (2) Transmissibilty Acquisition for Rectangular Grids

Based on the above definition of transmissibilty, for two adjacent rectangular grids with each grid face perpendicular to the corresponding coordinate axis, the transmissibilty is easy to be calculate, and must be one of TAₓ, TA_{y} and TA_{z}. The specific expressions are as follows:

$$\{ \begin{matrix}T {A}_{x} = \frac{0.5 ( {K}_{x} ( M ) + {K}_{x} ( N ) )}{0.5 ( {D}_{x} ( M ) + {D}_{x} ( N ) )} {D}_{y} ( M ) * {D}_{z} ( M ) \\ T {A}_{y} = \frac{0.5 ( {K}_{y} ( M ) + {K}_{y} ( N ) )}{0.5 ( {D}_{y} ( M ) + {D}_{y} ( N ) )} {D}_{x} ( M ) * {D}_{z} ( M ) \\ {TA}_{z} = \frac{0.5 ( {K}_{z} ( M ) + {K}_{z} ( N ) )}{0.5 ( {D}_{z} ( M ) + {D}_{z} ( N ) )} {D}_{x} ( M ) * {D}_{y} ( M )\end{matrix}$$

$$or \{ \begin{matrix}T {A}_{x} = {[ \frac{1}{{T}_{x} ( M )} + \frac{1}{{T}_{x} ( N )} ]}^{- 1} \\ T {A}_{y} = {[ \frac{1}{{T}_{y} ( M )} + \frac{1}{{T}_{y} ( N )} ]}^{- 1} \\ {TA}_{z} = {[ \frac{1}{{T}_{z} ( M )} + \frac{1}{{T}_{z} ( N )} ]}^{- 1}\end{matrix}$$

$${T}_{x} ( M ) = \frac{{K}_{x} ( M )}{D x ( M )} {D}_{y} ( M ) * {D}_{z} ( M )$$

$${T}_{y} ( M ) = \frac{{K}_{y} ( M )}{D y ( M )} {D}_{x} ( M ) * {D}_{z} ( M )$$

$${T}_{z} ( M ) = \frac{{K}_{z} ( M )}{D z ( M )} {D}_{x} ( M ) * {D}_{y} ( M )$$

$${T}_{x} ( N ) = \frac{{K}_{x} ( N )}{D x ( N )} {D}_{y} ( N ) * {D}_{z} ( N )$$

$${T}_{y} ( N ) = \frac{{K}_{y} ( N )}{D y ( N )} {D}_{x} ( N ) * {D}_{z} ( N )$$

$${T}_{z} ( N ) = \frac{{K}_{z} ( N )}{D z ( N )} {D}_{x} ( N ) * {D}_{y} ( N )$$

wherein:
M, N: the mark number of the adjacent grids (the grid N is the L-th adjacent grid of the grid M);
Kₓ(M), K_{y}(M), K_{z}(M) as well as Kₓ(N), K_{y}(N), K_{z}(N) are the permeabilities of the grid M and grid N in x, y, z directions;
Dₓ(M), D_{y}(M), D_{z}(M) as well as Dₓ(N), D_{y}(N), D_{z}(N) are the grid stepsizes of the grid M and grid N in x, y, z directions; the rest symbols have the same meaning as previously described.

In the rectangular grid simulation system, the directional permeabilities Kₓ, K_{y}, K_{z}, the grid stepsizes Dx, Dy, Dz of each grid in different directions are all known input parameters of the simulation model, and the corresponding transmissibilty values for the rectangular grid can be obtained by substituting the relevant parameters into the model above.

### (3) Algorithm for Transmissibilty of Unstructured Grids Based on Directional Permeability

For unstructured grids, to obtain the transmissibilty between two adjacent grids, it is necessary to first obtain the distance Dis_{L} between the centroids of the two grids, the effective seepage area A_{L} between the two grids, and the directional permeability K_{L} in the direction of fluid seepage. Obtaining of these parameters are as follows.
a. obtaining Dis_{L}
Centroid coordinates of the grid M are defined as (x_{M}, y_{M}, z_{M}), and centroid coordinates of its L-th adjacent grid are (x_{N}, y_{N}, z_{N}).

A vector connecting the centroids is the seepage direction vector ((x_{N}−x_{M})i, (y_{N}−y_{M})j, (z_{N}−z_{M})k) between the grids.

The modulus of the centroid direction vector is the distance between the centroids, i.e.

$$D i {s}_{L} = \sqrt{{( {x}_{N} - {x}_{M} )}^{2} + {( {y}_{N} - {y}_{M} )}^{2} + {( {z}_{N} - {z}_{M} )}^{2}}$$

b. obtaining effective seepage area A_{L} between adjacent grids

The common vertices between the grid M and its L-th adjacent grid N are projected onto the plane with the seepage direction vector as the normal vector, wherein the polygonal area formed by these projected points is the effective seepage area A_{L} between the adjacent grids. That is to say, the effective seepage area is equal to the projected area of the grid surface (seepage interface) on the plane with the seepage direction vector as the normal vector. The projected polygon is decomposed into a number of triangles, and the area of the projected polygon is obtained by summing the areas of these triangles.
c. obtaining the directional permeability K_{L}

The directional permeability is calculated based on a Scheidegger model, which is

$${K}_{L} = {K}_{x} {cos}_{{α}_{L}}^{2} + {K}_{y} {cos}_{{β}_{L}}^{2} + {K}_{z} {cos}_{{r}_{L}}^{2}$$

wherein:
α_{L}, β_{L}, r_{L} are the angles formed by the seepage direction vector of two adjacent grids and the x, y, z axes, respectively;

$$cos {α}_{L} = \frac{{x}_{N} - {x}_{M}}{\sqrt{{( {x}_{N} - {x}_{M} )}^{2} + {( {y}_{N} - {y}_{M} )}^{2} + {( {z}_{N} - {z}_{M} )}^{2}}}$$

$$cos {β}_{L} = \frac{{y}_{N} - {y}_{M}}{\sqrt{{( {x}_{N} - {x}_{M} )}^{2} + {( {y}_{N} - {y}_{M} )}^{2} + {( {z}_{N} - {z}_{M} )}^{2}}}$$

$$cos {γ}_{L} = \frac{{z}_{L} - {z}_{M}}{\sqrt{{( {x}_{N} - {x}_{M} )}^{2} + {( {y}_{N} - {y}_{M} )}^{2} + {( {z}_{N} - {z}_{M} )}^{2}}}$$

### SUMMARY OF THE PRESENT INVENTION

An object of the present invention is to provide a method for determining transmissibilty in numerical simulation of oil and gas reservoirs on unstructured grids, wherein based on the core seepage experimental data and well logging data of the drilled wells, the method takes into account the centroid distance of two adjacent grids as well as seepage direction vectors in the oil and gas reservoir simulation, and then adopts effective seepage area and directional permeability of the interface between the adjacent grids in seepage direction to calculate the transmissibilty. The present invention further verifies the reliability of the method by a rectangular grid example (rectangular grid is a special case of unstructured grids) whose accurate transmissibilty values can be obtained. The method of the present invention is simple, easy to understand and realize, operable, effective and practical, and has a good value of popularization and utilization.

Accordingly, in order to accomplish the above objects, the present invention provides:
a method for determining transmissibilty in numerical simulation of oil and gas reservoirs on unstructured grids, comprising steps of:
(1) according to drilled well trajectories in a reservoir simulation area and geological features comprising distribution of faults, distribution of large fractures, stratigraphic pinchout status and reservoir boundary morphology, using a professional grid generation tool to perform unstructured grid division, and obtaining vertex coordinates and adjacent grid mark numbers of each unstructured grid;
(2) determining centroid coordinates of each unstructured grid based on the vertex coordinates thereof;
(3) obtaining reservoir permeabilities Kx, Ky, Kz in x, y, z directions at a centroid of the unstructured grid based on core seepage experimental data and well logging data of drilled wells in the reservoir simulation area as well as geological modeling means;
(4) obtaining a seepage direction vector, which is a displacement pressure gradient direction, between adjacent unstructured grids based on the centroids of the adjacent unstructured grids; and obtaining direction cosines cos α_{L}, cos β_{L}, cos γ_{L} of the seepage direction vector;
(5) determining a distance Dis_{L} between the centroids of the adjacent unstructured grids;
(6) determining all shared vertex coordinates between the adjacent unstructured grids;
(7) determining an effective seepage area A_{L} between the adjacent unstructured grids in a seepage direction thereof with a projection method;
(8) based on the reservoir permeabilities of each unstructured grid in the x, y, z directions obtained in the step (3) and the seepage direction vector obtained in the step (4), determining a directional permeability K_{L} in the seepage direction between the adjacent unstructured grids with a Scheidegger model K_{L}=Kₓ cos_{α}_{_{L}}+K_{y} cos_{β}_{_{L}}²+K_{z} cosᵣ_{_{L}}²;
(9) based on a model

$$T {A}_{L} = \frac{{K}_{L}}{D i {s}_{L}} {A}_{L}$$

and the determined K_{L}, Dis_{L} and A_{L}, determining the transmissibilty between the adjacent unstructured grids.

Preferably, in the step (7), determining the effective seepage area A_{L} comprises specific steps of: determining a space plane equation perpendicular to the seepage direction, which is referred to as a seepage vertical plane, based on the seepage direction vector; then determining coordinates of projection points of all shared vertices between the adjacent unstructured grids on the seepage vertical plane; calculating an area of a polygon formed by the projection points on the seepage vertical plane, which is the effective seepage area A_{L} of the two adjacent unstructured grids in the seepage direction.

Preferably, during determining the effective seepage area A_{L}, the polygon formed by the projection points on the seepage vertical plane is decomposed into multiple triangles, and a sum of areas of the multiple triangles is the effective seepage area A_{L} in the seepage direction.

Determination of the transmissibilty in unstructured grid oil and gas reservoir simulation is an indispensable work in the application research of reservoir numerical simulation. Only on the basis of obtaining the transmissibilty of unstructured simulation grid, can we further carry out the field application research of numerical simulation of oil and gas reservoirs for the complex well trajectories such as fishbone branching wells, and for the complex geological features such as tilted faults, tilted fractures, stratigraphic pinchout, and reservoir boundaries of different shapes, so as to optimize the development technology policy of the oil and gas reservoirs, the distribution of residual oil and gas, and the field deployment as well as implementation of oil and gas wells.

Beneficial effect: The method of the present invention is simple, easy to understand and realize, operable, effective and practical, and has good value of popularization and utilization.

### BRIEF DESCRIPTION OF THE DRAWINGS

FIG. 1 illustrates vertex coordinates of two adjacent rectangular grids; and

FIG. 2 illustrates vertex coordinates of two adjacent unstructured grids.

### DETAILED DESCRIPTION OF THE PREFERRED EMBODIMENT

The technical solutions of the present invention will be further illustrated with preferred embodiments. However, the protection scope of the present invention is not limited thereto.

A method for determining transmissibilty in numerical simulation of oil and gas reservoirs on unstructured grids comprises steps of:
(1) according to drilled well trajectories in a reservoir simulation area and geological features comprising distribution of faults, distribution of large fractures, stratigraphic pinchout status and reservoir boundary morphology, using a professional grid generation tool to perform unstructured grid division, and obtaining vertex coordinates and adjacent grid mark numbers of each unstructured grid;
(2) determining centroid coordinates of each unstructured grid based on the vertex coordinates thereof;
(3) obtaining reservoir permeabilities Kx, Ky, Kz in x, y, z directions at a centroid of the unstructured grid based on core seepage experimental data and well logging data of drilled wells in the reservoir simulation area as well as geological modeling means;
(4) obtaining a seepage direction vector, which is a displacement pressure gradient direction, between adjacent unstructured grids based on the centroids of the adjacent unstructured grids; and obtaining direction cosines cos α_{L}, cos β_{L}, cos γ_{L} of the seepage direction vector;
(5) determining a distance Dis_{L} between the centroids of the adjacent unstructured grids;
(6) determining all shared vertex coordinates between the adjacent unstructured grids;
(7) determining an effective seepage area A_{L} between the adjacent unstructured grids in a seepage direction thereof with a projection method;
(8) based on the reservoir permeabilities of each unstructured grid in the x, y, z directions obtained in the step (3) and the seepage direction vector obtained in the step (4), determining a directional permeability K_{L} in the seepage direction between the adjacent unstructured grids with a Scheidegger model K_{L}=Kₓ cos_{α}_{_{L}}²+K_{y} cos_{β}_{_{L}}², +K_{z} cosᵣ_{_{L}}²;
(9) based on a model

$$T {A}_{L} = \frac{{K}_{L}}{D i {s}_{L}} {A}_{L}$$

and the determined K_{L}, Dis_{L} and A_{L}, determining the transmissibilty between the adjacent unstructured grids.

### Embodiment 1

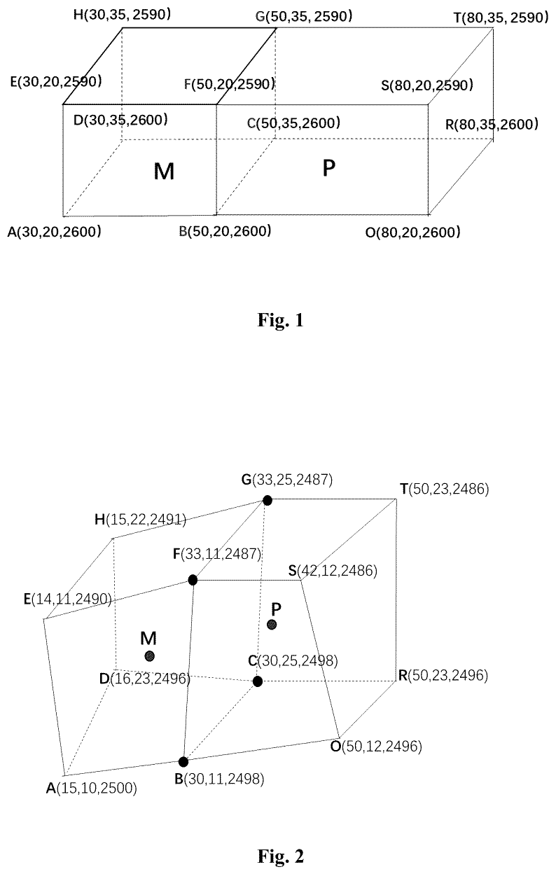

Since a regular rectangular grid can be viewed as a degraded unstructured grid, the transmissibilty between two adjacent rectangular grids can be obtained using the method of the present invention. For a rectangular grid, its transmissibilty can be easily and accurately obtained. The transmissibilty obtained by the method of the present invention is then compared with the accurate transmissibilty between two adjacent rectangular grids as described above for verifying the reliability of the method of the present invention.
(1) obtaining grid vertex coordinates of two adjacent reservoir simulation grids M and P by grid division; wherein as shown in FIG. 1, eight vertices of the grid M are A(30,20,2600), B(50,20,2600), C(50,35,2600), D(30,35,2600), E(30,20,2590), F(50,20,2590), G(50,35, 2590), and H(30,35, 2590); and eight vertices of the grid P are B(50,20,2600), O(80,20,2600), R(80,35,2600), C(50,35,2600), F(50,20,2590), S(80,20,2590), T(80,35,2590), and G(50,35,2590); shared vertices between the grid M and P are B(50,20,2600), C(50,35,2600), G(50,35, 2590), and F(50,20,2590);
(2) determining centroid coordinates as (40, 27.5, 2595) of the grid M based on the vertex coordinates thereof A(30,20,2600), B(50,20,2600), C(50,35,2600), D(30,35,2600), E(30,20,2590), F(50,20,2590), G(50,35, 2590), and H(30,35, 2590);
determining centroid coordinates as (65,27.5,2595) of the grid P based on the vertex coordinates thereof B(50,20,2600), O(80,20,2600), R(80,35,2600), C(50,35,2600), F(50,20,2590), S(80,20,2590), T(80,35,2590), and G(50,35,2590);
(3) based on core seepage experimental data and well logging data of drilled wells in the reservoir simulation area as well as geological modeling means, obtaining reservoir permeabilities Kₓ(M)=5 mD, K_{y}(M)=1.5 mD, K_{z}(M)=1 mD in x, y, z directions at a centroid of the grid M, and obtaining reservoir permeabilities Kₓ(P)=6 mD, K_{y}(P)=2 mD, K_{z}(P)=1.5 mD in x, y, z directions at a centroid of the grid P;
(4) obtaining a seepage direction vector (25 i, 0 j, 0 k) between adjacent unstructured grids based on the centroids (40, 27.5, 2595) and (65,27.5,2595) of the adjacent unstructured grids; and obtaining direction cosines cos α_{L}=1, cos β_{L}=0, cos γ_{L}=0 of the seepage direction vector;
(5) determining a distance Dis_{L}=25 between the centroids (40, 27.5, 2595) and (65,27.5,2595) of the adjacent unstructured grids;
(6) determining all shared vertex coordinates as B(50,20,2600), C(50,35,2600), G(50,35, 2590), and F(50,20,2590) between the adjacent unstructured grids;
(7) determining a space plane equation x=0 perpendicular to the seepage direction based on the seepage direction vector (25 i, 0 j, 0 k) obtained in the step (4); then determining coordinates B′(0,20,2600), C′0,35,2600), G′(0,35, 2590), and F′(0,20,2590) of projection points of all shared vertices B(50,20,2600), C(50,35,2600), G(50,35, 2590), and F(50,20,2590) between the adjacent grids on the plane x=0; wherein a polygon formed by the projection points can be decomposed into triangles B′C′G′ and B′G′F′; three side lengths of the triangle can be easily calculated based on the coordinates of the three vertices; according to a triangle area formula based on side lengths, it can be easily calculated that an area of the triangle B′C′G′ is 75, and an area of the triangle B′G′F′ is 75; thus the effective seepage area perpendicular to the seepage direction vector (25 i, 0 j, 0 k) is A_{L}=75+75=150;
(8) based on the reservoir permeabilities of each unstructured grid in the x, y, z directions obtained in the step (3) and the seepage direction vector obtained in the step (4), determining a directional permeability K_{L} in the seepage direction between the adjacent unstructured grids with a Scheidegger model K_{L}=Kₓ cos_{α}_{_{L}}²+K_{y} cos_{β}_{_{L}}²+K_{z} cosᵣ_{_{L}}²;
wherein according to the step (3), the permeabilities of the grid M in the x, y, and z directions are respectively Kₓ(M)=5 mD, K_{y}(M)=1.5 mD, K_{z}(M)=1 mD, and the permeabilities of its adjacent grid P in the x, y, and z directions are respectively Kₓ(P)=6 mD, K_{y}(P)=2 mD, K_{z}(P)=1.5 mD; when permeabilities at a grid interface in the x, y, z directions are an average of the corresponding permeabilities of the two adjacent grids, then:

$$K x = 0.5 ( {K}_{x} ( M ) + {K}_{x} ( P ) ) = 0.5 ( 5 + 6 ) = 5.5$$

$$Ky = 0.5 ( {K}_{y} ( M ) + {K}_{y} ( P ) ) = 0.5 ( 1.5 + 2 ) = 1 \text{.75}$$

$$Kz = 0.5 ( {K}_{z} ( M ) + {K}_{z} ( P ) ) = 0.5 ( 1 + 1.5 ) = 1.25$$

by substituting the above permeabilities Kx, Ky, Kz in x, y, z directions at the interface of two adjacent grids and the direction cosines cos α_{L}=1, cos β_{L}=0, cos γ_{L}=0 of the seepage direction vector obtained in the step (4) into the Scheidegger model K_{L}=Kₓ cos_{α}_{_{L}}²+K_{y} cos_{β}_{_{L}}²+K_{z} cosᵣ_{_{L}}², then:

$${K}_{L} = 5.5 \times + 1.75 \times {0}^{2} + 1.25 \times {0}^{2} = 5.5$$

(9) substituting Dis_{L}=25 obtained in the steps (5), A_{L}=150 obtained in the step (7) and K_{L}=5.5 obtained in the step (8) into a transmissibilty calculation model

$$T {A}_{L} = \frac{{K}_{L}}{D i {s}_{L}} {A}_{L} ,$$

then:

$$T {A}_{L} = \frac{5.5}{25} \times 150 = 33$$

which means the transmissibilty between two grids obtained by the method for determining the transmissibilty on unstructured grids is 33.

The following calculation determines the exact transmissibilty of the rectangular grids. Based on the vertex coordinates of the two rectangular grides M and P as shown in FIG. 1, it is easy to obtain that the grid stepsizes of the grid M in the x, y, and z directions are Dₓ(M)=20 m, D_{y}(M)=15 m, D_{z}(M)=10 m, respectively; and the grid stepsizes of the grid P in the x, y, and z directions are Dₓ(P)=30 m, D_{y}(P)=15 m, D_{z}(P)=10 m, respectively.

Since the grids M and P are adjacent in the x direction, the transmissibilty therebetween is TAₓ:

$$T {A}_{x} = \frac{0.5 ( {K}_{x} ( M ) + {K}_{x} ( P ) )}{0.5 ( {D}_{x} ( M ) + {D}_{x} ( P ) )} {D}_{y} ( M ) * {D}_{z} ( M )$$

$$T {A}_{x} = \frac{0.5 ( 5 + 6 )}{0.5 ( 20 + 30 )} \times 15 \times 10 = 33$$

Thus, the exact transmissibilty between rectangular grids M and P are 33. Obviously, the transmissibilty obtained by the method of the present invention is in agreement with the exact transmissibilty between these two adjacent grids, which verifies the reliability of the method of the present invention.

### Embodiment 2

(1) obtaining grid vertex coordinates of two adjacent reservoir simulation grids M and P by grid division; wherein as shown in FIG. 2, eight vertices of the grid M are A(15,10,2500), B(30,11,2498), C(30,25,2498), D(16,23,2496); E(14,11,2490), F(33,11,2487), G(33,25, 2487), H(15,22,2491); and eight vertices of the grid P are B(30,11,2498), O(50,12,2496), R(50,23,2496), C(30,25,2498); F(33,11,2487), S(42,12,2486), T(50,23, 2486), G(33,25, 2487); shared vertices between the grid M and Pare B(30,11,2498), C(30,25,2498), G(33,25, 2487), and F(33,11,2487);
(2) determining centroid coordinates as (23.922, 17.089, 2493.306) of the grid M based on the vertex coordinates thereof A(15,10,2500), B(30,11,2498), C(30,25,2498), D(16,23,2496), E(14,11,2490), F(33,11,2487), G(33,25, 2487), and H(15,22,2491);
determining centroid coordinates as (39.148, 18.000, 2492.215) of the grid P based on the vertex coordinates thereof B(30,11,2498), O(50,12,2496), R(50,23,2496), C(30,21,2498), F(33,11,2487), S(42,12,2486), T(50,23, 2486), and G(33,21,2487);
(3) based on core seepage experimental data and well logging data of drilled wells in the reservoir simulation area as well as geological modeling means, obtaining reservoir permeabilities Kₓ(M)=5 mD, K_{y}(M)=1.5 mD, K_{z}(M)=1 mD in x, y, z directions at a centroid of the grid M, and obtaining reservoir permeabilities Kₓ(P)=6 mD, K_{y}(P)=2 mD, K_{z}(P)=1.5 mD in x, y, z directions at a centroid of the grid P;
(4) obtaining a seepage direction vector (15.226 i, 0.911j,−1.091k) between adjacent unstructured grids based on the centroids (23.922, 17.089, 2493.306) and (39.148, 18.000, 2492.215) of the adjacent unstructured grids; and obtaining direction cosines cos α_{L}=0.9957, cos β_{L}=0.0596, cos γ_{L}=−0.0713 of the seepage direction vector;
(5) determining a distance Dis_{L}=15.292 between the centroids (23.922, 17.089, 2493.306) and (39.148, 18.000, 2492.215) of the adjacent unstructured grids;
(6) determining all shared vertex coordinates as B(30,11,2498), C(30,25,2498), G(33,25, 2487), and F(33,11,2487) between the adjacent unstructured grids;
(7) determining a space plane equation 15.2226×x+0.911×y−1.091×z=0 perpendicular to the seepage direction based on the seepage direction vector (15.226 i, 0.911j,−1.091k) obtained in the step (4); then determining coordinates B′(177.0225, 19.7966, 2487.4670) C′(176.1921, 33.7469, 2487.5265), G′(175.4368, 33.5223,2476.7955), and F′(176.2672, 19.5719, 2476.7361) of projection points of all shared vertices B(30,11,2498), C(30,25,2498), G(33,25, 2487), and F(33,11,2487) between the adjacent grids on the plane 15.2226×x+0.911×y−1.091×z=0; wherein a polygon formed by the projection points can be decomposed into triangles B′C′G′ and B′G′F′; three side lengths of the triangle can be easily calculated based on the coordinates of the three vertices; according to a triangle area formula based on side lengths, it can be easily calculated that an area of the triangle B′C′G′ is 75.1688, and an area of the triangle B′G′F′ is 75.1688; thus the effective area perpendicular to the seepage direction vector (15.226 i, 0.911j,−1.091k) is A_{L}=75.1688+75.1688=150.3376;
(8) based on the reservoir permeabilities of each unstructured grid in the x, y, z directions obtained in the step (3) and the seepage direction vector obtained in the step (4), determining a directional permeability K_{L} in the seepage direction between the adjacent unstructured grids with a Scheidegger model K_{L}=Kₓ cos α_{L}²+Kγ cos_{β}_{_{L}}²+K_{z} cosᵣ_{_{L}}²;
wherein according to the step (3), the permeabilities of the grid M in the x, y, and z directions are respectively Kₓ(M)=5 mD, K_{y}(M)=1.5 mD, K_{z}(M)=1 mD, and the permeabilities of its adjacent grid P in the x, y, and z directions are respectively Kₓ(P)=6 mD, K_{y}(P)=2 mD, K_{z}(P)=1.5 mD; when permeabilities at a grid interface in the x, y, z directions are an average of the corresponding permeabilities of the two adjacent grids, then:

$$K x = 0.5 ( {K}_{x} ( M ) + {K}_{x} ( P ) ) = 0.5 ( 5 + 6 ) = 5.5$$

$$Ky = 0.5 ( {K}_{y} ( M ) + {K}_{y} ( P ) ) = 0.5 ( 1.5 + 2 ) = 1 \text{.75}$$

$$Kz = 0.5 ( {K}_{z} ( M ) + {K}_{z} ( P ) ) = 0.5 ( 1 + 1.5 ) = 1.25$$

by substituting the above permeabilities Kx, Ky, Kz in x, y, z directions at the interface of two adjacent grids and the direction cosines cos α_{L}=0.9957, cos β_{L}=0.0596, cos γ_{L}=−0.0713 of the seepage direction vector obtained in the step (4) into the Scheidegger model K_{L}=Kₓ cos_{α}_{_{L}}²+K_{y} cos_{β}_{_{L}}²+K_{z} cosᵣ_{_{L}}², then:

$${K}_{L} = 5.5 \times 0 {\text{.9957}}^{2} + 1.75 \times {0.0596}^{2} + 1.25 \times {( - 0.0713 )}^{2} = 5.4651$$

(9) substituting Dis_{L}=15.292 obtained in the steps (5), A_{L}=150.3376 obtained in the step (7) and K_{L}=5.4651 obtained in the step (8) into a transmissibilty calculation model

$$T {A}_{L} = \frac{{K}_{L}}{D i {s}_{L}} {A}_{L} ,$$

then:

$$T {A}_{L} = \frac{5.4651}{15.292} \times 150.3376 = 53.7271$$

which means the transmissibilty between two grids obtained by the method for determining the transmissibilty on unstructured grids is 53.7271.

It should be noted that for an irregular hexahedron, three-dimensional numerical integration is necessary to obtain the centroid, which is relatively complicated. In practice, the average of the coordinates of each vertex of the hexahedron can be used as the centroid coordinates. For example, in the above two irregular grids, the centroid coordinates of the grid M obtained by averaging the coordinates is (23.25,16.75,2493.375), which is very close to the centroid coordinates (23.922,17.089,2493.306) obtained by integration; and the centroid coordinates of the grid P obtained by averaging the coordinates is (39.75,17.75,2491.75), which is also very close to the centroid coordinates (39.148, 18.000, 2492.215) obtained by integration. The transmissibilty between the two grids obtained by averaging the coordinates is 48.81, which is also close to the transmissibilty 53.7271 obtained by integration, wherein a relative error therebetween is about 9.15%, which satisfies engineering applications.

The above embodiments are the preferred embodiments of the present invention, but the implementation of the present invention is not limited by the above embodiments. Any other modifications not deviating from the present invention shall be equivalent replacements, and are included in the protection scope of the present invention.

What is claimed is:

1. A method for determining transmissibilty in numerical simulation of oil and gas reservoirs on unstructured grids, comprising steps of:
(1) according to drilled well trajectories in a reservoir simulation area and geological features comprising distribution of faults, distribution of large fractures, stratigraphic pinchout status and reservoir boundary morphology, using a grid generation tool to perform unstructured grid division, and obtaining vertex coordinates and adjacent grid mark numbers of each unstructured grid;
(2) determining centroid coordinates of each unstructured grid based on the vertex coordinates thereof;
(3) obtaining reservoir permeabilities Kx, Ky, Kz in x, y, z directions at a centroid of the unstructured grid based on core seepage experimental data and well logging data of drilled wells in the reservoir simulation area as well as geological modeling means;
(4) obtaining a seepage direction vector, which is a displacement pressure gradient direction, between adjacent unstructured grids based on the centroids of the adjacent unstructured grids; and obtaining direction cosines cos α_{L}, cos β_{L}, cos γ_{L} of the seepage direction vector;
(5) determining a distance Dis_{L} between the centroids of the adjacent unstructured grids;
(6) determining all shared vertex coordinates between the adjacent unstructured grids;
(7) determining an effective seepage area A_{L} between the adjacent unstructured grids in a seepage direction thereof with a projection method;
(8) based on the reservoir permeabilities of each unstructured grid in the x, y, z directions obtained in the step (3) and the seepage direction vector obtained in the step (4), determining a directional permeability K_{L} in the seepage direction between the adjacent unstructured grids with a Scheidegger model K_{L}=Kₓ cos_{α}_{_{L}}², +K_{y} cos_{β}_{_{L}}²+K_{z} cosᵣ_{_{L}}²;
(9) based on a model
$$T {A}_{L} = \frac{{K}_{L}}{D i {s}_{L}} {A}_{L}$$
and the determined K_{L}, Dis_{L} and A_{L}, determining the transmissibilty between the adjacent unstructured grids.

2. The method, as recited in claim 1, wherein in the step (7), determining the effective seepage area A_{L} comprises specific steps of: determining a space plane equation perpendicular to the seepage direction, which is referred to as a seepage vertical plane, based on the seepage direction vector; then determining coordinates of projection points of all shared vertices between the adjacent unstructured grids on the seepage vertical plane; calculating an area of a polygon formed by the projection points on the seepage vertical plane, which is the effective seepage area A_{L} of the two adjacent unstructured grids in the seepage direction.

3. The method, as recited in claim 2, wherein during determining the effective seepage area A_{L}, the polygon formed by the projection points on the seepage vertical plane is decomposed into multiple triangles, and a sum of areas of the multiple triangles is the effective seepage area A_{L} in the seepage direction.
